(19) United States
(12) Patent Application Publication
(10) Pub. No.: US 2009/0241751 A1
(43) Pub. Date: Oct. 1, 2009

(54) MICROTOME HAVING A VARIABLE SECTIONING STROKE, USING A LINEAR MOTOR AS A DRIVE SYSTEM

(76) Inventor: Roland Walter, Reilingen (DE)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(21) Appl. No.: 12/410,344

(22) Filed: Mar. 24, 2009

(30) Foreign Application Priority Data
Mar. 28, 2008 (DE) 102008016165.9

(51) Int. Cl. G01N 1/06; B26D 7/06

(52) U.S. Cl. 83/703; 83/167; 83/707; 83/713; 83/714

(57) ABSTRACT

A microtome for generating thin sections of a specimen is suggested, comprising: a sectioning knife with a knife edge coming into engagement with the specimen during generation of the thin sections along a sectioning plane, an advance unit that generates at an angle to the sectioning plane between two thin sections an advance that defines the thickness of the thin section, a linear motor having a linear stator and a linear rotor, the linear motor generating a linear relative motion between the knife edge and the specimen in order to create the thin section, wherein the linear stator generates a traveling magnetic field that drives the linear rotor, and a control unit for controlling the linear motor for performing a relative back-and-forth motion along a predetermined displacement traveling path and for controlling the advance unit between two thin sections.

### CROSS-REFERENCE TO RELATED APPLICATION

This application claims the priority of the German patent application DE 102008016165.9 having a filing date of Mar. 28, 2008, the entire content of which is herewith incorporated by reference.

### BACKGROUND OF THE INVENTION

To an increasing extent, microtomes are being equipped with motorized drive units. DE 196 30 382 discloses a microtome in which at least one specimen holder, having the specimen that is to be sectioned, is arranged on a rotatably mounted disc. The sectioning operation between specimen and sectioning knife is accomplished by rotation of the disc, the specimen being guided over the sectioning knife. A motorized rotational drive system is provided in order to generate the rotational motion of the disk.

In the microtome described, because of the mechanical design the sectioning stroke is not modifiable. This has the disadvantage that a long sectioning stroke, although suitable for large specimens and for specimen changing, nevertheless decreases sample throughput for small specimens. This sample throughput indicates how many thin sections of a sample or specimen can be produced per unit time over a predetermined travel length (the displacement travel). In the context of a sectioning operation for sectioning small specimens with a non-modifiable sectioning stroke and a long displacement travel, a high sectioning speed is therefore necessary in order to produce thin sections in a reasonably short time. As a result, wear on the sectioning knife is increased and the section quality of the thin sections is greatly degraded.

DE 199 11 005 discloses a rotating disc microtome in which the motor-adjustable parameters of the microtome are set via a control circuit. The required sectioning speed is set, for example, by an automatic determination of the distance between the sectioning plane and the specimen to be sectioned. The closer the specimen comes to the cutting edge, the lower the sectioning speed. Automated determination of the distance between the sectioning plane and specimen can thus be used to regulate the sectioning speed.

### SUMMARY OF THE INVENTION

It is an object of the invention to create a microtome, having a variable sectioning stroke, that enables a rapid sectioning operation on specimens of different sizes and is of simple construction.

This object is achieved by the combination of features of claim 1. Advantageous refinements are indicated in the dependent claims.

According to the invention, a linear motor is used in order to generate a linear relative motion between the knife edge of the sectioning knife and the specimen to be sectioned. This motor makes possible, in direct fashion, a back-and-forth motion for implementing the thin sections. The displacement travel of the linear motor can easily be set with the aid of a control unit. For example, the displacement travel can be selected so that it is only just larger than the specimen to be sectioned. The sectioning operation between specimen and sectioning knife then occurs along the displacement travel, which also corresponds substantially to the sectioning stroke. A high sample throughput at a relatively low sectioning speed can thereby be achieved.

According to an exemplifying embodiment of the invention, the displacement travel can be settable via the control unit. This can be accomplished, for example, with the aid of a control panel, such that an operator inputs the endpoints of the displacement travel into the control unit. Another possibility is to define the endpoints of the displacement travel using a handwheel. These endpoints then define the sectioning window. The handwheel is connected to an incremental transducer that senses the rotation angle of the handwheel and delivers corresponding electrical signals to the control unit. The control unit then controls the linear motor in accordance with the rotation angle of the handwheel, so that the endpoints of the displacement travel can be controlled.

It is possible for the specimen being sectioned to be arranged on the movable linear rotor of the linear motor, the sectioning knife being mounted on the stationary advance unit. In this case the specimen executes the motion necessary for generating the thin section. Alternatively, the sectioning knife can be mounted on the movable linear rotor, and the specimen being sectioned is arranged on the stationary advance unit. In this case the sectioning knife executes the motion necessary for generating the thin section. In a further variant, the advance unit having the sectioning knife is mounted on the movable linear rotor. The specimen being sectioned is arranged in stationary fashion. In this case the advance unit and sectioning knife execute the motion necessary for generating the thin section. Because a linear motor is used, no mechanical linkage is needed in order to convert a rotational motion into a linear motion. The distance traveled by the linear motor, and its speed, are specified solely by the control unit and its drive signals. This accordingly results in a simplified configuration for the motor-driven microtome.

It is advantageous if a maintenance region, into which the linear motor can be shifted for service work and for work on the specimen, is provided outside the sectioning window in the direction of the displacement travel. This maintenance region can be located well outside the sectioning region along the linear extension of the displacement travel. For example, specimen exchange is performed in this maintenance region; or a separate block cooling unit, with which the specimen can be cooled, is arranged in the maintenance region.

### BRIEF DESCRIPTION OF THE DRAWINGS

The invention will be explained below with reference to exemplifying embodiments in conjunction with drawings, in which:

FIG. 1 is a schematic depiction showing the configuration of a microtome;

FIG. 2 is a schematic depiction of a linear motor;

FIG. 3 schematically depicts an embedded sample in a sample bed filled with paraffin; and

FIG. 4 is a schematic sketch of the displacement travel for sectioning the specimen, also showing movement into a maintenance region.

### DETAILED DESCRIPTION OF THE DRAWINGS

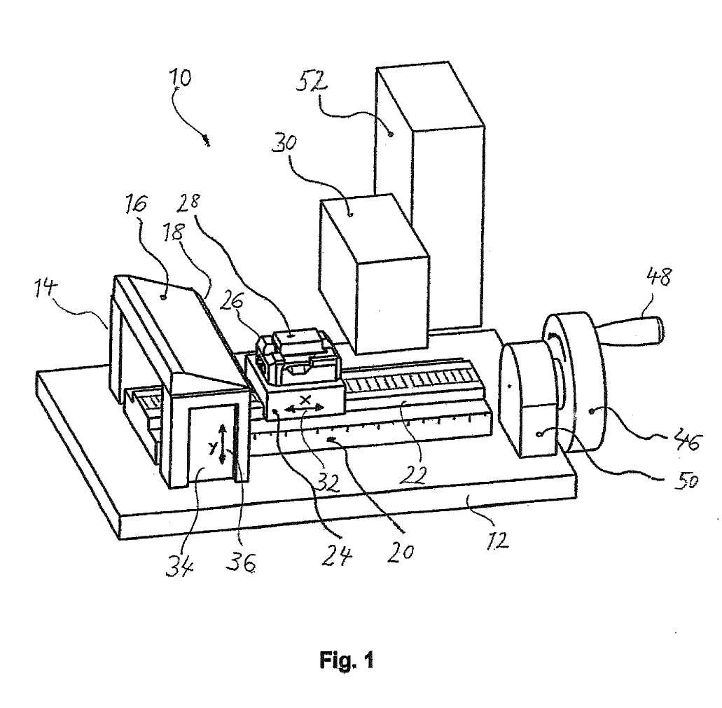

FIG. 1 is a general, simplified depiction showing a microtome 10 having a base bed 12 and a knife block 14, arranged thereon, that carries a knife holder 16. This knife holder 16 holds a sectioning knife 18 that encompasses a knife edge.

Also mounted on base bed 12 is a rail element 20 having a linear stator 22 arranged thereon. Mounted shiftably on rail element 20 is a linear rotor 24 movable in a horizontal direction, and encompassing a specimen holder 26 and an associated specimen 28, which rotor can execute back-and-forth motions in the direction of double arrow X as a result of control application signals of a control unit 30, in order to implement thin sections on specimen 28 in coaction with sectioning knife 18. Specimen 28 is, for example, a biological sample of tissue material, micrometer-thin sections of which are to be produced for microscopy.

A handwheel 46 having an associated handle 48 serves for manual control of the motion of linear rotor 24. Handwheel 46 is mechanically coupled to an incremental transducer 50 that generates electrical signals corresponding to the rotation angle of handwheel 46 and forwards them to controller 30. Controller 30 is designed so that when an operator rotates handwheel 46 clockwise or counterclockwise through a rotation angle of 360°, a preselected sectioning stroke or displacement travel of linear rotor 24 is executed, the center of the sectioning stroke being located in the region of the knife edge. The sectioning stroke is freely adjustable under the operator's control; for small samples, the shortest possible sectioning stroke should be set in order to achieve a high sample throughput.

Relative displacement of sectioning knife 18 in the Y direction with respect to specimen holder 26 is effected by an advance unit 34 in the direction of Y double arrow 36, the section thickness of the thin section being thereby defined. An advance is performed between each two back-and-forth motions of linear rotor 24. A block cooling unit 52 is also provided in order to cool specimen 28.

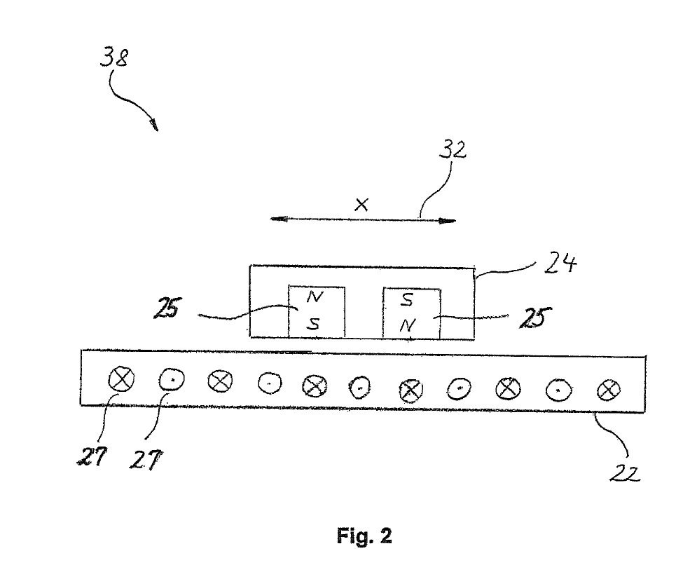

FIG. 2 is a schematic depiction showing the configuration of linear motor 38, encompassing the stationary linear stator 22 having a multi-phase winding system, and the movable linear rotor 24 having permanent magnets 25. When a current flows in windings 27 of linear stator 22, a traveling magnetic field is created. The consequence of this is that alternating electrical voltages are induced in linear rotor 24. These induced voltages cause the generation, in linear rotor 24, of eddy currents which generate a magnetic field and thereby exert an electromagnetic force on linear rotor 24. This results in a linear motion of linear rotor 24 in the direction of X double arrow 32.

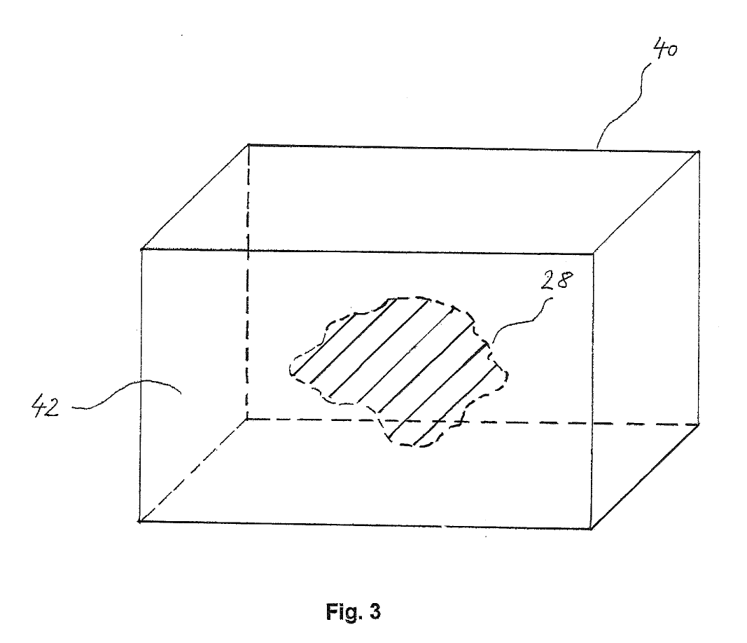

FIG. 3 schematically depicts specimen 28 to be sectioned, for example a sample of biological tissue material, which is received in a sample bed 40 filled with paraffin 42.

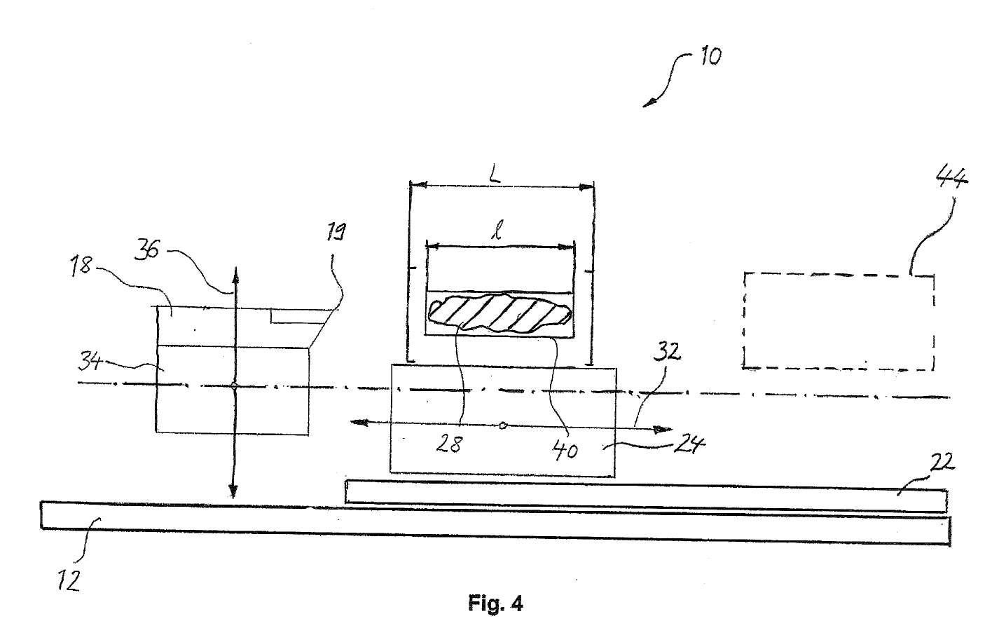

FIG. 4 is a simplified side view depicting microtome 10. In this exemplifying embodiment, embedded specimen 28 is depicted in sample bed 40 that has a length l. The sectioning operation between specimen 28 and knife edge 19 of sectioning knife 18 is accomplished by a linear back-and-forth motion of linear rotor 24 along a predetermined displacement travel L. Displacement travel L for sectioning specimen 28 should be only slightly longer than length l of sample bed 40, so that the greatest possible sample throughput can be achieved.

In an operating state in which no thin sections are being produced, the spacing between knife edge 19 of sectioning knife 18 and specimen 28 should be relatively large, for example so that a specimen change can be carried out. For this purpose, linear rotor 24, and sample bed 40 arranged thereon, are moved by control unit 30 toward the right to a maintenance region 44. Block cooling unit 52 for cooling the sample can then also, for example, be arranged in this maintenance region 44. An automatic block changing unit, a block moisturizing unit, and a data reader can also, for example, be provided in maintenance region 44.

Further variants differing from FIG. 1 are possible as embodiments of the invention. For example, the relative displacement of sectioning knife 18 with respect to specimen holder 26 having specimen 28 can also be accomplished by means of advance unit 34 obliquely at an angle, or perpendicularly, to the sectioning plane of the thin section. For example, knife holder 16 having cutting knife 18 can be arranged on the movable linear rotor 28, while specimen holder 26 having specimen 28 is mounted on the stationary advance unit 34. Advance unit 34 can also be arranged on the movable linear rotor 24 together with specimen holder 26 and specimen 28, sectioning knife 18 being mounted in stationary fashion. In another variant of the invention, advance unit 34 can be arranged on linear rotor 28, knife holder 16 having sectioning knife 18 being mounted on that advance unit 34. Specimen 28 to be sectioned is then arranged in stationary fashion.

In FIGS. 1 and 4, rail element 20 with linear stator 22 arranged thereon is arranged parallel to the surface of base bed 12, linear rotor 28 being mounted shiftably in a horizontal direction on linear stator 22. Alternatively, it is also possible to arrange rail element 20, having linear stator 22 arranged thereon, in the direction of the surface normal line of base bed 12 or obliquely at an angle thereto, thereby defining the direction of displacement travel L of linear rotor 28. The force of gravity acting on linear rotor 28 can thereby also be utilized in the context of the feed motion.

A variety of advantages are achieved by way of the invention. A sliding microtome that, in one embodiment, encompasses a movable specimen holder is made available. The production of thin sections of different specimen sizes can be accomplished much more quickly with the use of a microtome utilizing the linear drive motor, since the displacement travel that must be effected can be adapted to the specimen size. The linear back-and-forth motion of the sectioning knife in the context of the sectioning operation can therefore be accomplished at a decreased speed for an otherwise unchanged sample throughput. With this procedure, stress on the sectioning knife is decreased and the quality of the thin sections is improved.

### LIST OF COMPONENT PARTS

10 Microtome

12 Base bed

14 Knife block

16 Knife holder

18 Sectioning knife

19 Knife edge

20 Rail element

22 Linear stator

24 Linear rotor

25 Permanent magnet

26 Specimen holder

27 Winding

28 Specimen

30 Control unit

32 Double arrow in X direction

34 Advance unit

36 Double arrow in Y direction

38 Linear motor

40 Sample bed

42 Paraffin

44 Maintenance region

46 Handwheel

48 Handle

50 Incremental transducer

52 Block cooling unit

1. A microtome for generating thin sections of a specimen, comprising:
a sectioning knife with a knife edge coming into engagement with the specimen during generation of the thin sections along a sectioning plane,
an advance unit that generates at an angle to the sectioning plane between two thin sections an advance that defines the thickness of the thin section,
a linear motor having a linear stator and a linear rotor, said linear motor generating a linear relative motion between the knife edge and the specimen in order to create the thin section, wherein the linear stator generates a traveling magnetic field that drives the linear rotor, and
a control unit for controlling the linear motor for performing a relative back-and-forth motion along a predetermined displacement traveling path and for controlling the advance unit between two thin sections.

2. The microtome according to claim 1, wherein the specimen to be sectioned is arranged on the movable linear rotor and the sectioning knife is arranged on the stationary advance unit.

3. The microtome according to claim 1, wherein the sectioning knife is arranged on the movable linear rotor and the specimen to be sectioned is arranged on the stationary advance unit.

4. The microtome according to claim 1, wherein the advance unit with the sectioning knife is supported by the movable linear rotor and the specimen to be sectioned in arranged in stationary fashion.

5. The microtome according to claim 1, wherein the advance unit is supported with the specimen to be sectioned by the movable linear rotor and the sectioning knife is arranged in stationary fashion.

6. The microtome according to claim 1, wherein the specimen is held by a specimen holder.

7. The microtome according to claim 6, wherein the specimen is received in a sample bed filled with paraffin.

8. The microtome according to claim 1, wherein the sectioning action involving the predeterminable displacement traveling path is adjustable by the control unit.

9. The microtome according to claim 7, wherein in an operating mode for sectioning the specimen into thin sections the length of the displacement traveling path is slightly longer than a length of the sample bed.

10. The microtome according to claim 9, wherein the length of the displacement traveling path is 1.5 to 3 times longer than the length of the sample bed.

11. The microtome according to claim 9, wherein the length of the displacement traveling path is 1.1 to 1.3 times longer than the length of the sample bed.

12. The microtome according to claim 8, wherein in an operating mode for exchanging the specimen the linear rotor provides a displacement into a maintenance region outside the displacement traveling path.

13. The microtome according to claim 1, wherein the advance unit generates the advance between two thin sections at an angle of approximately 900 to the sectioning plane.

14. The microtome according to claim 1, wherein a separate block cooling unit that cools the specimen is arranged in the maintenance region.

15. The microtome according to claim 1, wherein a handwheel that is connected to an incremental encoder is provided as an operating element for operating the control unit.
